(19) United States
(12) Patent Application Publication
(10) Pub. No.: US 2024/0303258 A1
(43) Pub. Date: Sep. 12, 2024

(54) INTELLIGENT SYSTEM IDENTIFICATION AND CONNECTIVITY CREATION

(71) Applicant: International Business Machines Corporation, Armonk, NY (US)

(72) Inventors: Dharma Teja Atluri, Hyderabad (IN); Siddhartha Sood, Ghaziabad (IN); Santanu Ghosh, Kolkata (IN); Moumee Chanda, Kolkata (IN)

(21) Appl. No.: 18/181,596

(22) Filed: Mar. 10, 2023

(51) Int. Cl. G06F 16/28; G06F 16/22; G06F 16/2457; G06F 16/2458; G06F 40/40; G06N 20/00

(52) U.S. Cl. CPC G06F 16/288; G06F 16/2228; G06F 16/24578; G06F 16/2465; G06F 40/40; G06N 20/00

(57) ABSTRACT

Computer-implemented methods for system identification and connectivity creation. Aspects include obtaining, by the processor, customer data and applying one or more natural language processing techniques to the customer data to generate one or more entities for a first data structure. Aspects also include generating one or more predicted entities based on the one or more entities and analyzing the one or more predicted entities of the first data structure to determine a candidate source system, wherein the one or more predicted entities include one or more connection parameters. Aspects further include generating a system environment to connect the candidate source system to the target system based on the first data structure.

### BACKGROUND

The present disclosure relates generally to system connectivity, and more specifically, to a method and system for intelligent system identification and connectivity creation.

Organizations use a variety of business software applications, servers and network devices in their businesses. This variety is typically a combination of disparate source systems which include on-premises and cloud-based systems. Implementing connectivity between these disparate source systems to a target system or systems requires repeated manual perusal and research of available information to obtain different skills based on the product type to generate the connection and to ensure the right configuration with best practices. This requires different data formats and sources of information than what would be needed for consumption for a set of requirements. Thus, a solution is required that would enable identifying source system entities that would be needed to cater to the requirements along with how to automate the connectivity between the source systems and the target systems.

### SUMMARY

Embodiments of the present invention are directed to a computer-implemented method for system identification and connectivity creation. According to an aspect, a computer-implemented method includes obtaining, by the processor, customer data and applying one or more natural language processing techniques to the customer data to generate one or more entities for a first data structure. The method also includes generating one or more predicted entities based on the one or more entities. The method also includes analyzing the one or more predicted entities of the first data structure to determine a candidate source system, wherein the one or more predicted entities include one or more connection parameters. The method further includes generating a system environment to connect the candidate source system to the target system based on the first data structure.

In one or more embodiments of the present invention, the one or more predicted entities of the first data structure to determine a candidate source system includes data-mining a data usage repository including a set of data structures to determine a similarity score of the first data structure to a second data structure in the set of data structures, wherein the second data structure is associated with the candidate source system, comparing the similarity score to a threshold similarity score, and returning the candidate source system based on the similarity score exceeding the threshold similarity score.

In one or more embodiments of the present invention, analyzing the one or more predicted entities of the first data structure to determine a candidate source system includes web scraping a set of allow-list links to identify one or more connectivity parameters, determining a similarity score of the one or more predicted entities to the one or more connectivity parameters associated with the candidate source system, comparing the similarity score to a threshold similarity score, and returning the candidate source system based on the similarity score exceeding the threshold similarity score.

In one or more embodiments of the present invention, the one or more predicted entities comprise at least one of firewall rules and port identification.

In one or more embodiments of the present invention, generating the one or more predicted entities includes generating, by a machine learning algorithm, a feature vector comprises a plurality of features extracted from the customer data, plotting the feature vector in a multidimensional feature space, and returning the one or more predicted entities based on a geometric distance of the feature vector and the one or more predicted entities being below a threshold distance.

In one or more embodiments of the present invention, the method also includes receiving, by the processor, customer feedback associated with the first data structure.

In one or more embodiments of the present invention, the method also includes updating the machine learning algorithm based on the customer feedback.

In one or more embodiments of the present invention, the customer data comprises source system data, compliance data, regulatory data, and data type.

In one or more embodiments of the present invention, the natural language processing technique comprises at least one of tokenization, lemmatization, Word2Vec, and latent Dirichlet allocation.

In one or more embodiments of the present invention, wherein the customer data comprises unstructured data.

According to another non-limiting embodiment of the invention, a system having a memory having computer readable instructions and one or more processors for executing the computer readable instructions, the computer readable instructions controlling the one or more processors to perform operations. The operations include obtaining, by the processor, customer data and applying one or more natural language processing techniques to the customer data to generate one or more entities for a first data structure. The operations also include generating one or more predicted entities based on the one or more entities. The operations also include analyzing the one or more predicted entities of the first data structure to determine a candidate source system, wherein the one or more predicted entities include one or more connection parameters. The operations further include generating a system environment to connect the candidate source system to the target system based on the first data structure.

According to another non-limiting embodiment of the invention, a computer program product for system identification and connectivity creation is provided. The computer program product includes a computer-readable storage medium having program instructions embodied therewith, the program instructions executable by a processor to cause the processor to perform operations. The operations include obtaining, by the processor, customer data and applying one or more natural language processing techniques to the customer data to generate one or more entities for a first data structure. The operations also include generating one or more predicted entities based on the one or more entities. The operations also include analyzing the one or more predicted entities of the first data structure to determine a candidate source system, wherein the one or more predicted entities include one or more connection parameters. The operations further includes generating a system environment to connect the candidate source system to the target system based on the first data structure.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of a system for an intelligent system identification and connectivity creation in accordance with one or more embodiments of the present invention;

FIG. 3 depicts a representation of a data structure according to one or more embodiments of the invention; and

FIG. 4 illustrates a block diagram of a method for system identification and connectivity creation according to one or more embodiments.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

There are multiple integration software options available which allow for manual assessment of data quality and data availability across all critical dimensions. For example, Enterprise Information/Integration management (EIM) tools are available that allow the handling of Extract-Transformation-Load (ETL) or Extract-Load-Transformation (ELT) processes. However, these tools still require a user to manually create the source system connections by first creating the type of end point within the source system and then going into the target system and creating the other connection end point to be able to establish the connection between the source and target system. This also requires the identifying of the required ports and firewall connectivity that need to be configured manually. This would require working with a network subject matter expert (SME) to establish the network prior to being able to establish the connectivity between the systems. Further, it would need to be determined whether the source system related data extraction has met the regulatory and/or compliance requirements and, also, the system owner would need to manually design the system to handle the PI/SPI based data when being consumed through the source system connection to the target system. This all, currently, requires manual processes requiring different tools.

As discussed above, identifying and creating connectivity between a source system and a target system typically requires use of subject matter experts performing manual tasks. Disclosed herein are methods, systems and computer program products for intelligent system identification and connectivity creation. Aspects of the invention provide solutions for the problem of automatically identifying source system entities that would be required to cater to the requirements for a target system and also includes how to automate the connectivity between a source and a target system.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as system identification and connectivity creation 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

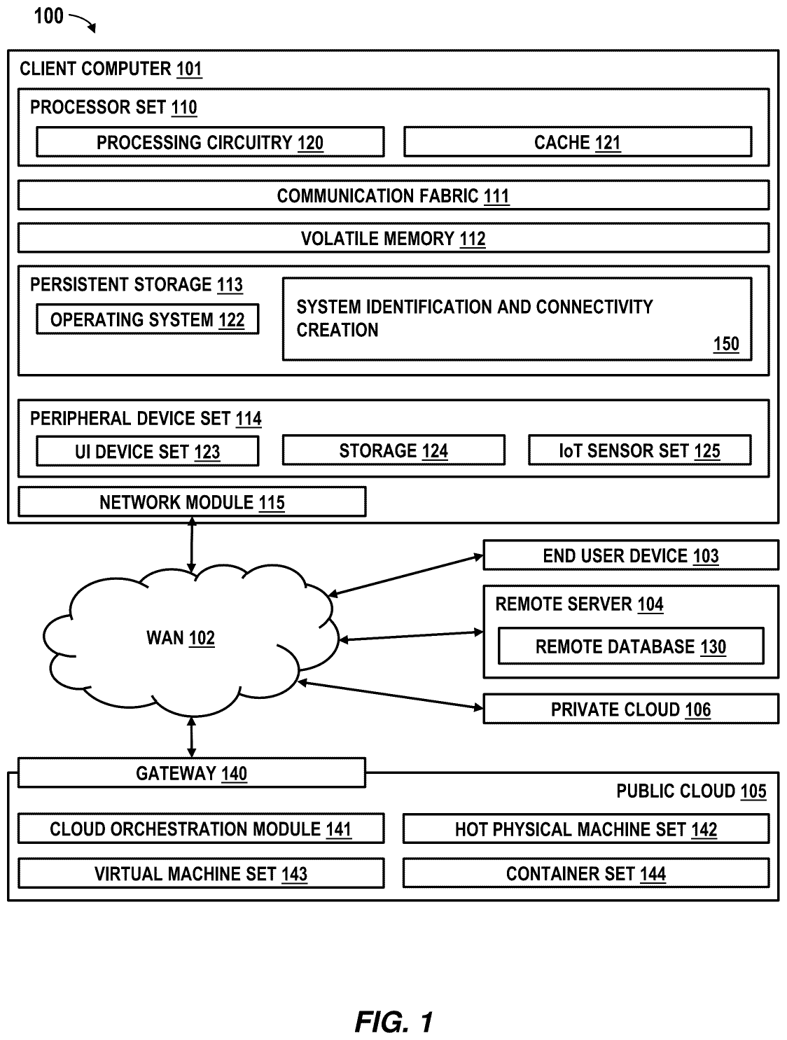

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

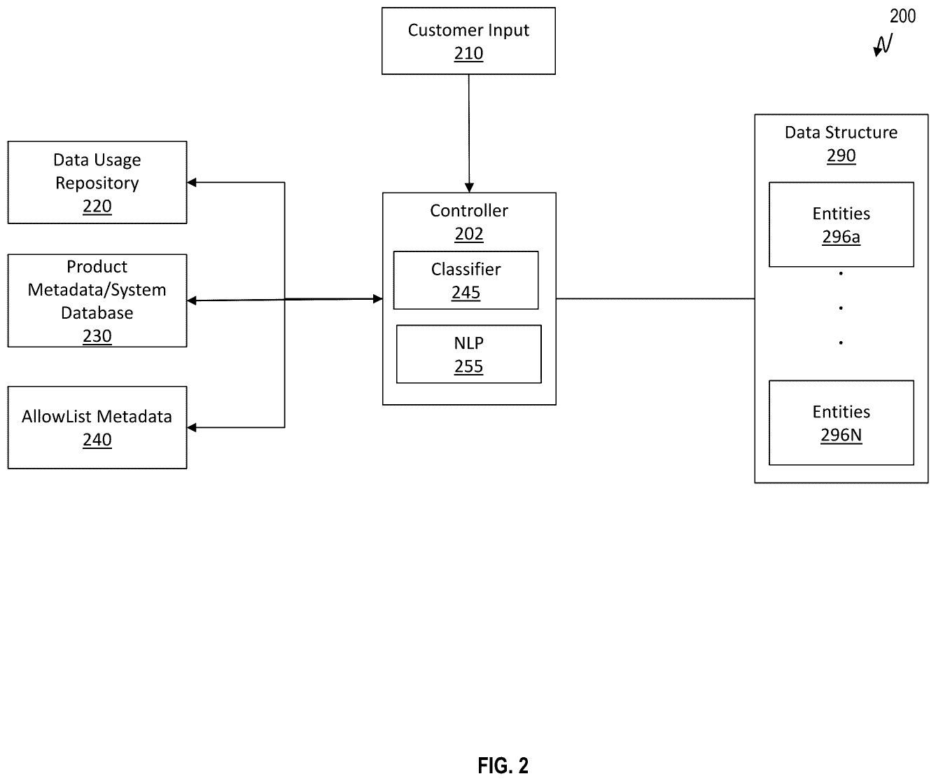

Referring now to FIG. 2, a block diagram of a system 200 for an intelligent system identification and connectivity creation is generally shown in accordance with one or more embodiments of the present invention. The system 200 automates the connectivity between a target and source system based on functional and non-functional requirements such as, for example, business requirements of data consumption and regulatory/compliance requirements. Further, the system 200 executes methods that establish the connectivity between a source and target system without going through the manual effort of establishing network, firewall, ports, and actual connection type.

The system 200 includes a controller 202 with a machine learning classifier 245 and natural language processing (NLP) 255. The controller 202 operates to receive and/or obtain customer input 210 that includes customer requirements for business data and target system information. The customer requirements include functional and non-function requirements for a target system that includes data requirements such as usability, reporting or other process handling, sensitivity handling, regulatory and compliance checks, and the like. The customer data also includes information related to source customer system data, target system data output requirements, network configuration requirements, connection type requirements, firewall configuration requirements, regulatory and compliance requirements, and the like.

The controller 202 accesses a variety of information sources including a data usage repository 220, a product metadata/system database 230, and allow-listed links 240 knowledge base. The controller 202 accesses the data usage repository 220 to check similar historic requirements which can be utilized to predict entities 296a-N for the data structure 290. The controller 202 utilizing the classifier 245 identifies a candidate source system by selecting customer requirements that are a closest match (e.g., having a similarity score within a threshold score) and populating the entities in the data structure based on the historical requirements in the data usage repository 220. The classifier 245 can utilize a variety of machine learning techniques including, but not limited to, logistic regression, SVM classification, and ensemble analysis. When the data usage repository 220 includes historical data structures that are a close match, the entities 296a-N are generated into the data structure 290 and a source system is identified. The controller 202 analyzes the entities 296a-N in the data structure 290 to determine if enough product metadata is available to fully populate the data structure 290. Product metadata is supplemented into the data structure by the controller 202 searching the product metadata/system database 230. And if the entities 296a-N remain unpopulated from the data usage repository and product metadata/system database, the controller 202 can search the internet using an “allow-listed” set of links 240. The “allow-listed” links include, but are not limited to, product factsheets maintained by a vendor. The internet search, by the controller 202, can be performed using techniques such as web scrapping to identify features and other connectivity parameters for input as entities 296a-N in the data structure 290. The connectivity parameters can include firewall requirements, port type requirements, and network requirements for the source system and the target system.

The entities 296a-N in the data structure 290 can be further checked against any regulatory or compliance requirements extracted from the customer input 210 to ensure all required processes are validated based on requirements in the source system. The data structure 290 can be provided to the customer by the controller 202. The customer can provide feedback to the controller as to the data structure 290 which now includes connection type, network infrastructure design defining ports, system configuration, and firewalls impacted. The customer feedback can be utilized as training data for the classifier 245. The controller 202 with the data structure 290 can then generate a system environment to connect the proposed source system with the target system.

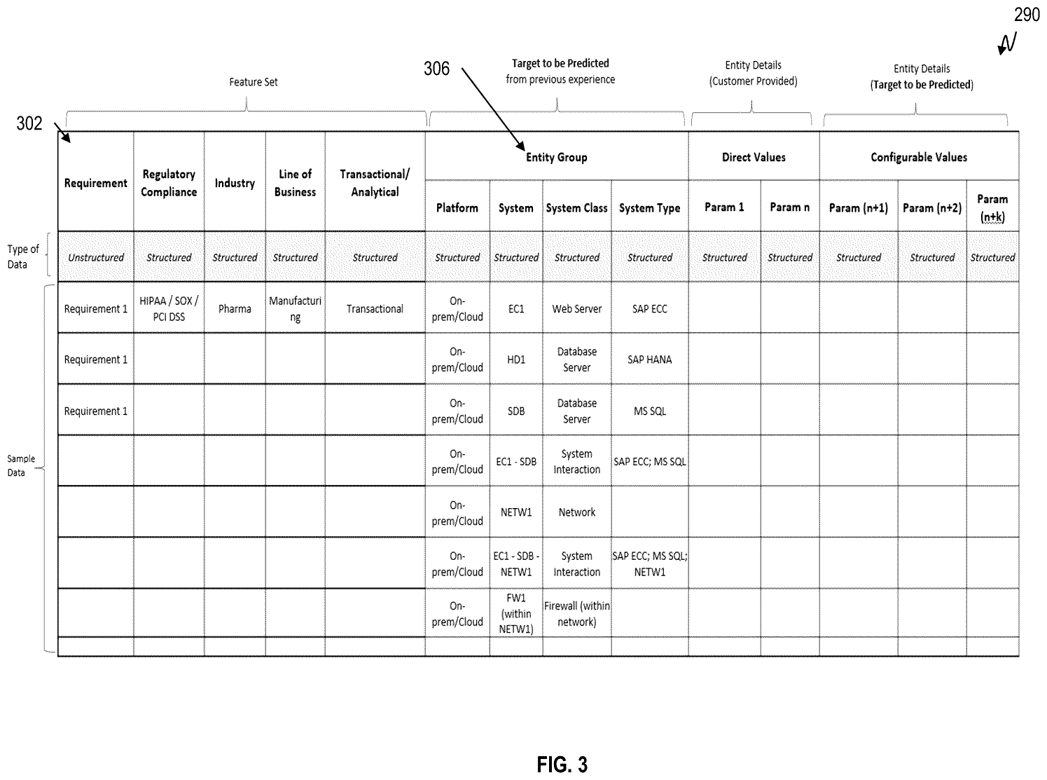

FIG. 3 depicts a representation of a data structure according to one or more embodiments of the invention. The data structure 290 is represented by a table with a variety of headers and associated data. In the illustrated example, the data structure 290 has headers as requirements, regulatory compliance, industry, line of business, transactional/analytical, entity group, and entity details. The entity group has sub headers shown as platform, system, system class, and system type. The entity details includes both direct values and configurable values. The headers and data included in the example data structure 290 are intended to be illustrative and are not intended to be limiting.

In one or more embodiments of the invention, the data structure 290 includes the customer requirements 302 which is in the form of unstructured data as shown in the type of data row. The controller 202 (from FIG. 2) utilizes NLP to extract requirements and populates the data structure 290. The regulatory compliance, industry, line of business, and transactional/analytical columns are populated with metadata by the controller 202. The controller 202 using the classifier 245 determines from the data usage repository 220 the metadata for these columns. The entity group and entity details are then populated with predicted metadata (i.e., predicted entities) using the techniques described earlier and in further detail below.

In one or more embodiments of the invention, the entity groups 306 are predicted based on the user requirements. The user requirements 302 can include unstructured and structured data. The unstructured data can be cleaned (i.e., remove characters, e.g. punctuations) and tokenized. Stop word and other text processing techniques can be applied to the unstructured data. Further, lemmatization can be applied to the unstructured data and then a supervised learning algorithm can be applied the unstructured data. Supervised learning techniques include, but are not limited to, word2vec and latent Dirichlet allocation. As mentioned earlier, the processed unstructured data is compared to historical data structures in the data usage repository 220. Further, structured date from the customer can be analyzed using supervised learning techniques such as classifier/naïve Bayes to analyze the structured features. These can be utilized to populate the structured data headers (e.g., regulatory compliance, industry, line of business, and transactional/analytical).

The entity configurations (i.e., parameters for entity set up connections) are predicted using the classifier 245 that generates a feature vector (set) as shown in the data structure 290. This feature vector can be plotted in a feature space representation of other data structures in the data usage repository 220. A geometric distance calculation can be utilized to determine other data structures associated with one or more source systems that are within a threshold distance. This can be referred to as a similarity score for the data structure 290 with respect to another existing data structure in the data usage repository. The existing data structure within a similarity score threshold can be utilized to extract entity parameters to populate the data structure 290. The entity parameters are utilized to determine a system environment that can connect the target customer system with a potential source system.

The data structure 290 includes system connectivity outputs along with metadata, type of data accessible in the target system from the candidate source system, and a proposed mapping with different tables identified for connectivity. In one or more embodiments, the customer input 210 can include feedback from the customer regarding the data structure entries and the proposed source system. The customer feedback can be utilized for additional training for the classifier 245.

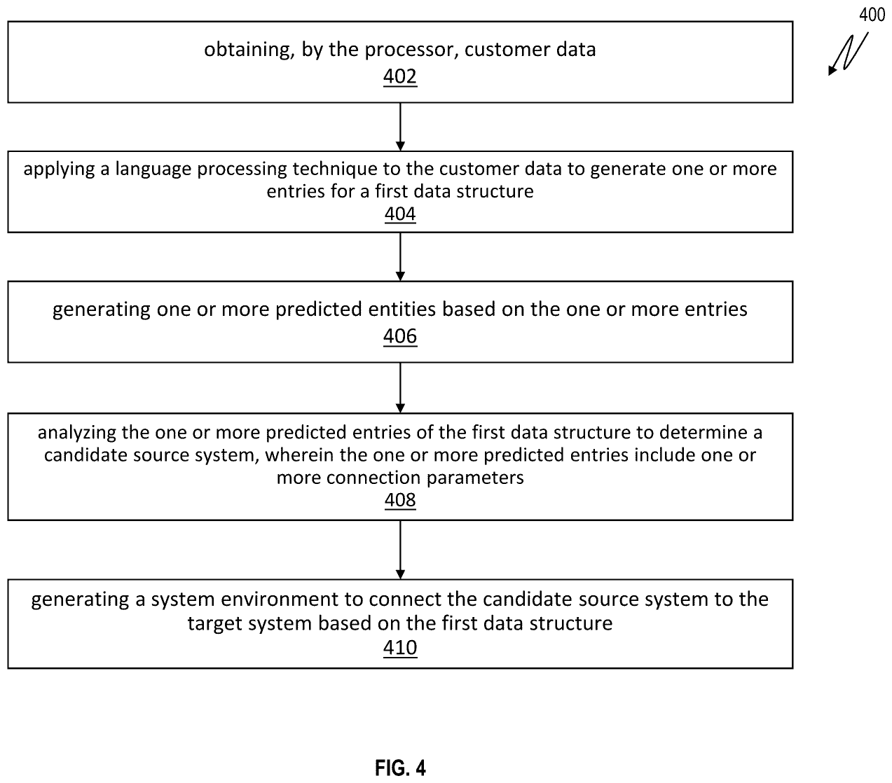

FIG. 4 illustrates a block diagram of a method for system identification and connectivity creation according to one or more embodiments. The method 400 includes obtaining, by the processor, customer data, as shown in block 402. The method 400, at block 404, includes applying one or more natural language processing techniques to the customer data to generate one or more entities for a first data structure. Also, at block 406, the method 400 includes generating one or more predicted entities based on the one or more entities. The method 400 also includes analyzing the one or more predicted entities of the first data structure to determine a candidate source system, wherein the one or more predicted entities include one or more connection parameters, as shown at block 408. And at block 410, the method 400 includes generating a system environment to connect the candidate source system to the target system based on the first data structure.

Additional processes may also be included. It should be understood that the processes depicted in FIG. 4 represent illustrations, and that other processes may be added or existing processes may be removed, modified, or rearranged without departing from the scope and spirit of the present invention.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,”“comprising,”“includes,”“including,”“has,”“having,”“contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,”“substantially,”“approximately,” and variations thereof, are intended to include the degree of error associated with measurement of the particular quantity based upon the equipment available at the time of filing the application. For example, “about” can include a range of ±8% or 5%, or 2% of a given value.

What is claimed:

1. A computer-implemented method for system identification and connectivity creation, the method comprising:
obtaining, by the processor, customer data;
applying one or more natural language processing techniques to the customer data to generate one or more entities for a first data structure;
generating one or more predicted entities based on the one or more entities;
analyzing the one or more predicted entities of the first data structure to determine a candidate source system, wherein the one or more predicted entities include one or more connection parameters; and
generating a system environment to connect the candidate source system to a target system based on the first data structure.

2. The computer-implemented method of claim 1, wherein analyzing the one or more predicted entities of the first data structure to determine the candidate source system comprises:
data-mining a data usage repository including a set of data structures to determine a similarity score of the first data structure to a second data structure in the set of data structures, wherein the second data structure is associated with the candidate source system;
comparing the similarity score to a threshold similarity score; and
returning the candidate source system based on the similarity score exceeding the threshold similarity score.

3. The computer-implemented method of claim 1, wherein analyzing the one or more predicted entities of the first data structure to determine the candidate source system comprises:
web scraping a set of allow-list links to identify one or more connectivity parameters;
determining a similarity score of the one or more predicted entities to the one or more connectivity parameters associated with the candidate source system;
comparing the similarity score to a threshold similarity score; and
returning the candidate source system based on the similarity score exceeding the threshold similarity score.

4. The computer-implemented method of claim 1, wherein the one or more predicted entities comprise at least one of firewall rules and port identification.

5. The computer-implemented method of claim 1, wherein generating the one or more predicted entities comprises:
generating, by a machine learning algorithm, a feature vector comprises a plurality of features extracted from the customer data;
plotting the feature vector in a multidimensional feature space; and
returning the one or more predicted entities based on a geometric distance of the feature vector and the one or more predicted entities being below a threshold distance.

6. The computer-implemented method of claim 5, further comprising:
receiving, by the processor, customer feedback associated with the first data structure.

7. The computer-implemented method of claim 6, further comprising:
updating the machine learning algorithm based on the customer feedback.

8. The computer-implemented method of claim 1, wherein the customer data comprises unstructured data.

9. The computer-implemented method of claim 1, wherein the customer data comprises source system data, compliance data, regulatory data, and data type.

10. The computer-implemented method of claim 1, wherein the one or more natural language processing techniques comprises at least one of tokenization, lemmatization, Word2Vec, and latent Dirichlet allocation.

11. A system comprising:
a memory having computer readable instructions; and
one or more processors for executing the computer readable instructions, the computer readable instructions controlling the one or more processors to perform operations comprising:
obtaining customer data;
applying one or more natural language processing techniques to the customer data to generate one or more entities for a first data structure;
generating one or more predicted entities based on the one or more entities;
analyzing the one or more predicted entities of the first data structure to determine a candidate source system, wherein the one or more predicted entities include one or more connection parameters; and
generating a system environment to connect the candidate source system to a target system based on the first data structure.

12. The system of claim 11, wherein analyzing the one or more predicted entities of the first data structure to determine the candidate source system comprises:
data-mining a data usage repository including a set of data structures to determine a similarity score of the first data structure to a second data structure in the set of data structures, wherein the second data structure is associated with the candidate source system;
comparing the similarity score to a threshold similarity score; and
returning the candidate source system based on the similarity score exceeding the threshold similarity score.

13. The system of claim 11, wherein analyzing the one or more predicted entities of the first data structure to determine the candidate source system comprises:
web scraping a set of allow-list links to identify one or more connectivity parameters;
determining a similarity score of the one or more predicted entities to the one or more connectivity parameters associated with the candidate source system;
comparing the similarity score to a threshold similarity score; and
returning the candidate source system based on the similarity score exceeding the threshold similarity score.

14. The system of claim 11, wherein the one or more predicted entities comprise at least one of firewall rules and port identification.

15. The system of claim 11, wherein generating the one or more predicted entities comprises:
generating, by a machine learning algorithm, a feature vector comprises a plurality of features extracted from the customer data;
plotting the feature vector in a multidimensional feature space; and
returning the one or more predicted entities based on a geometric distance of the feature vector and the one or more predicted entities being below a threshold distance.

16. A computer program product comprising a computer readable storage medium having program instructions embodied therewith, the program instructions executable by a processor to cause the processor to perform operations comprising:
obtaining customer data;
applying one or more natural language processing techniques to the customer data to generate one or more entities for a first data structure;
generating one or more predicted entities based on the one or more entities;
analyzing the one or more predicted entities of the first data structure to determine a candidate source system, wherein the one or more predicted entities include one or more connection parameters; and
generating a system environment to connect the candidate source system to a target system based on the first data structure.

17. The computer program product of claim 16, wherein analyzing the one or more predicted entities of the first data structure to determine the candidate source system comprises:
data-mining a data usage repository including a set of data structures to determine a similarity score of the first data structure to a second data structure in the set of data structures, wherein the second data structure is associated with the candidate source system;
comparing the similarity score to a threshold similarity score; and
returning the candidate source system based on the similarity score exceeding the threshold similarity score.

18. The computer program product of claim 16, wherein analyzing the one or more predicted entities of the first data structure to determine the candidate source system comprises:
web scraping a set of allow-list links to identify one or more connectivity parameters;
determining a similarity score of the one or more predicted entities to the one or more connectivity parameters associated with the candidate source system;
comparing the similarity score to a threshold similarity score; and
returning the candidate source system based on the similarity score exceeding the threshold similarity score.

19. The computer program product of claim 16, wherein the one or more predicted entities comprise at least one of firewall rules and port identification.

20. The computer program product of claim 16, wherein generating the one or more predicted entities comprises:
generating, by a machine learning algorithm, a feature vector comprises a plurality of features extracted from the customer data;
plotting the feature vector in a multidimensional feature space; and
returning the one or more predicted entities based on a geometric distance of the feature vector and the one or more predicted entities being below a threshold distance.
